(19) United States
(12) Patent Application Publication
(10) Pub. No.: US 2017/0351349 A1
(43) Pub. Date: Dec. 7, 2017

(54) FLUID PRESSURE FORCE SENSOR INTERFACE

(71) Applicant: Microsoft Technology Licensing, LLC, Redmond, WA (US)

(72) Inventors: Jay Michael Fassett, Edmonds, WA (US); Bradley Edgar Clements, Fort Collins, CO (US); Michael Dale Jensen, Duvall, WA (US); Gabriel Pirie, Seattle, WA (US); Xiaoyue Xie, Beijing (CN)

(21) Appl. No.: 15/170,500

(22) Filed: Jun. 1, 2016

(51) Int. Cl. G06F 3/0354; G06F 3/041; G01L 7/02; G01L 19/14

(52) U.S. Cl. CPC G06F 3/03545; G06F 3/0414; G01L 7/02; G01L 19/14

(57) ABSTRACT

The described technology includes a fluid force sensor interface between a pressure sensor, such as a barometric pressure sensor disposed inside a sensor housing with an aperture, and a container with an interior cavity exposed to the ambient environmental fluid pressure. The interior cavity of the container may equalize with the pressure of the ambient fluid environment, and may cooperate with the aperture on the sensor housing to create at least a partial fluid seal. A force member may transmit an applied outside force to deform the container, and the interior cavity therein, to reduce the volume of the interior cavity and thus increase pressure inside the interior cavity. The fluid force sensor may measure the applied force by sensing an increase in pressure inside the interior cavity. After the outside applied force has been removed, the pressure inside the interior cavity may equalize with the ambient fluid pressure.

### BACKGROUND

Electronic devices may accept user input dependent on the application of a force by the user to the electronic device or to an associated peripheral device. For example, a stylus peripheral for use with a tablet computer or smart phone may sense the force applied to the tip of the stylus and switch from a hover mode to an ink mode when the force applied by a user satisfies a minimum force condition. The stylus may sense increasing force and transmit a signal indicating the received force level to an electronic device accordingly. Peripherals that accept user input dependent on force often experience distortions from changes in environmental conditions, such as temperature, pressure, etc. These distortions may lead to user input inaccuracies and diminished user experience.

### SUMMARY

The described technology includes a fluid force sensor interface between a pressure sensor, such as a barometric pressure sensor disposed inside a sensor housing with an aperture, and a container with an interior cavity exposed to the ambient environmental fluid pressure. The interior cavity of the container may equalize with the pressure of the ambient fluid environment, and may cooperate with the aperture on the sensor housing to create at least a partial fluid seal. A force member may transmit an applied outside force to deform the container, and the interior cavity therein, to reduce the volume of the interior cavity and thus increase pressure inside the interior cavity. The fluid force sensor may measure the applied force by sensing an increase in pressure inside the interior cavity. After the outside applied force has been removed, the pressure inside the interior cavity may equalize with the ambient fluid pressure. The sensor may operate at a wide range of ambient fluid pressures without recalibration because the applied force measurement may depend on a change in fluid pressure inside the interior cavity, and not on the absolute value of the fluid pressure measurement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example barometric pressure force sensor in a stylus peripheral in a hover mode.

FIG. 2 illustrates an example barometric pressure force sensor in a stylus peripheral in an ink mode.

FIG. 3 is a plot of fluid pressure inside an interior cavity against barometric sensor output.

FIG. 4 illustrates an example container with an interior cavity configured to cooperate with the aperture on a barometric sensor housing.

FIG. 5 illustrates another example container with an interior cavity configured to cooperate with the aperture on a barometric sensor housing.

FIG. 6 illustrates another example container with an interior cavity configured to cooperate with the aperture on a barometric sensor housing with an applied force.

FIG. 7 illustrates another example container with an interior cavity configured to cooperate with the aperture on a barometric sensor housing without an applied force.

FIG. 8 illustrates another example container with an interior cavity configured to cooperate with the aperture on a barometric sensor housing with an applied force.

FIG. 9 illustrates another example container with an interior cavity configured to cooperate with the aperture on a barometric sensor housing without an applied force.

FIG. 10 illustrates another example container with an interior cavity configured to cooperate with the aperture on a barometric sensor housing with an applied force.

FIG. 11 is a plot of fluid pressure inside the interior cavity of a container against time.

FIG. 12 illustrates another example container with an interior cavity configured to cooperate with the aperture on a barometric sensor housing without an applied force.

FIG. 13 illustrates another example container with an interior cavity configured to cooperate with the aperture on a barometric sensor housing with an applied force.

FIG. 14 illustrates example operations for sensing an applied force.

FIG. 15 illustrates an example system that may be useful in implementing the described technology.

### DETAILED DESCRIPTIONS

A fluid pressure force sensor interface includes a fluid pressure sensor, such as a barometric pressure sensor disposed inside a sensor housing with an aperture, and a container with an interior cavity exposed to the ambient environmental fluid pressure. The fluid force sensor may be used in a hand-held stylus designed for use as a peripheral with electronic devices, including smart phones, tablets, watches, desktop computers, gaming devices, wearable devices, televisions, video conferencing systems, etc. The fluid pressure force sensor interface is equipped with a deformable container having an interior cavity and an opening in the interior cavity to the ambient fluid environment, which may include the ambient fluid pressure. The interior cavity is configured to cooperate with the port of a fluid sensor, such as a barometric sensor. When a user applies a force to an applicator of the fluid pressure force sensor, such as the tip of a stylus, a pressure member decreases the volume, and thus increases the pressure, inside the interior cavity. When the user applies no force to the applicator (or, in an implementation, a force below a minimum force condition), the pressure in the interior cavity of the deformable container may equalize with the ambient environmental fluid pressure through the exterior opening, and the port of the fluid sensor may also calibrate (or tare) to ambient environmental pressure through the exterior opening or via a gap between the container and the housing of the fluid pressure sensor. There is no need for an additional fluid pressure sensor to measure a reference ambient environmental pressure because both the inside of the interior cavity of the container and the environment of the fluid pressure sensor return to the same ambient fluid pressure when there is no force on the applicator regardless of changes in environmental pressure.

A stylus or pen may communicate user input to an electronic device. The stylus may be powered by a battery, which may be a rechargeable battery, a replaceable battery, or a disposable battery. The stylus may include, as explained in more detail below, capabilities to support one or more wired or wireless communications protocols. In one implementation, antennas may be disposed inside or outside the stylus to communicate with electronic devices according to a variety of communications protocols. The stylus may include features such as one or more physical buttons selectable by a user. In one implementation, they stylus may include a clip that may also function as a physical button, an antenna, or an information indicator such as, for example but without limitation, by including an LED light or display. In implementations, the stylus may include user feedback features such as haptic feedback, audio alerts through one or more audio speakers, vibration user feedback, etc.

The stylus may operate according to one or modes of operation. The stylus may determine an appropriate mode of operation based on environmental conditions that may be sensed according to one or more sensors on the stylus. In another implementation, the stylus may determine an appropriate mode of operation according to an internal metric, for example without limitation, if a predetermined amount of time has passed since the stylus has received an input from the user or data from a paired device. In yet another implementation, a mode of operation may be selected by the user, for example without limitation, by pushing a button or switch on the device or by causing a sensor on the device to receive an input.

One mode of operation may be a stand-by mode, such as a low power mode or sleep mode. The stylus may enter stand-by mode, for example, when the stylus has been idle for a predetermined amount of time. Stand-by mode may conserve battery power by cutting power to unneeded subsystems of the stylus. The stylus may be woken up from stand-by mode by the user in a variety of ways, such as pressing a button on the stylus housing or applying pressure to the tip. In another implementation, the stylus may be awakened from stand-by mode or powered on remotely, such as by connecting a cable or wirelessly via a Bluetooth™ connection, a Wi-Fi connection, NFC communications, activation of an on-board sensor such as an accelerometer, heat sensor, noise sensor, or temperature sensor. Another mode of operation of the stylus may be an active mode. In active mode, the various subsystems on-board the stylus may be powered up. For example, without limitation, a communications system may power up in active mode, and attempt to establish a connection with an electronic device.

The stylus may also include a hover mode. In hover mode, a user may control the position of a pen cursor or pointer by directing the tip of the stylus at the screen of the electronic device without making physical contact with the screen. The stylus may detect hover mode when there is no pressure applied to the tip, but the stylus is within a predetermined distance from the screen of the electronic device.

Another mode of the stylus may be an ink mode, also known as a draw mode or write mode. The stylus may operate in ink mode when a pressure is applied to the tip of the stylus sufficient to satisfy an ink condition. The ink condition may be, for example without limitation, a minimum force applied to the stylus tip. Ink mode may be used to select an area of the screen of the electronic device indicated by the position of the tip. In ink mode, the electronic device may interpret input as drawing on the screen, such as for drawing a figure or when writing text. The stylus may sense various weights of ink depending on the amount of pressure applied to the stylus tip. For example, a light touch may indicate a relatively finer line should be drawn on the device. As the user increases pressure on the stylus, the weight of the line may increase accordingly. The stylus may therefore detect a binary condition indicating whether the stylus should draw or hover, and also, in ink mode, detect a pressure to indicate the weight of a line to be drawn. In one implementation, the stylus may sense 4096 or more discrete weights depending on the amount of pressure applied to the stylus against the screen of the electronic device.

Barometric pressure sensors measure force needed to stop a liquid or gas from expanding. To provide a pressure reading, a pressure sensor may need to establish a reference pressure against which a sensed pressure may be measured. One way of establishing a reference pressure is to use the local atmospheric pressure, also known as a differential pressure sensor. A differential pressure sensor is vented to the atmosphere surrounding the sensor. When a port in the sensor is exposed to the atmosphere, the sensor may indicate a pressure of zero. When a pressure is applied to the port, the sensor may report a pressure value indicating the difference between the ambient pressure and the applied pressure. Another way of establishing a reference pressure is to use a sealed pressure sensor. A sealed pressure sensor may include a hermetically sealed container that remains at a fixed internal pressure regardless of changing ambient conditions. A sealed pressure sensor may include a reference barometric sensor in contact with the sealed container to provide a reference pressure. A sealed pressure sensor may include a port exposed to the ambient atmosphere to expose a second barometric sensor to the ambient fluid pressure, which may include the ambient air pressure. If the ambient pressure equals the pressure inside the sealed container, the sealed pressure sensor will report a pressure of zero. If the ambient pressure surrounding the sealed pressure sensor differs from the pressure inside the sealed container, then the sealed pressure sensor will report a value indicating the difference.

The type of barometric pressure sensor used in the present stylus is an absolute sensor. An absolute sensor may include a single port and single barometric pressure sensor that measures pressure relative to a vacuum. Absolute barometric pressure sensors are available with a large dynamic range, e.g., up to 24-bit of data after the output has been sent through an analog-to-digital converter (ADC). The high dynamic range of the sensors may afford a wider range of pressure measurements than is likely to be needed for the environmental conditions in which the sensor is expected to operate. In other words, the range of expected measurements for the real-world environmental conditions experienced by the sensor may fit into a smaller output space such as 16- or 12-bits of data, thus relaxing the mechanical tolerances needed to construct the device because it is possible for the sensor to still sense all encountered environmental pressures even if there is some “drift” due to less stringent mechanical tolerances within the 24-bit range.

The force sensor disclosed herein may employ an absolute barometric sensor with a configurable output. Configuring output includes without limitation adjusting the gain on the sensor and/or adjusting the range of pressures the sensor is configured to report. Configuring the output of the sensor permits several modes of operation that may not be available with other types of sensors. It may be desired for the sensor to have a large resolution response for part of an applied force window, but a relatively lower resolution response for another part of an applied force window. For example, if the force on the stylus tip is expected to range from 0-350 g, the output of the sensor could be configured to provide a high resolution response in the window 0 g-100 g, and a lower resolution response in the window 100-350 g because it is likely that most users will operate the stylus in the 0-100 g range the majority of the time, and the users may desire a finer response in that range. If the stylus detects an applied force is in the 0-100 g range, it may dynamically configure the output of the sensor to provide a larger response resolution by using a relatively larger portion of the range of the sensor. If the stylus detects an applied force above 100 g, it may dynamically configure the sensor to include forces up to 350 g (or above) to continue detecting applied force, but with less precision than in the lower range. In one implementation, the output of the sensor in the stylus may be so configured as to meet a logarithmic response curve specification. When the stylus is in a hover mode, a high resolution response may be desired for pressures near the ambient fluid pressure to detect a force needed to switch the stylus to an ink mode. In hover mode, the output of the sensor may be configured to provide such a large resolution response until an applied force has been detected that is deemed sufficient satisfy an ink condition, for example over a range of 0-5 g.

The stylus is capable of passively compensating for a wide range of ambient fluid pressure without calibration because the stylus relies on the high dynamic range of the sensor to sense changes in pressure (referred to herein as ΔP) when a force is applied to the tip no matter where the ΔP occurs within the sensor's range. The stylus may calibrate the sensor to a zero level when the sensor when the stylus wakes up from a sleep mode or under a variety of other conditions, as explained below. The calibration operation may zero (or “tare”) the sensor to the ambient fluid pressure because the sensor is exposed to the ambient fluid pressure when there is no force applied to the tip. Once the stylus has been zeroed to the ambient pressure, any measured increase in pressure can be attributed to a force on the tip, regardless of the actual reading reported by the sensor. In other words, the stylus may rely only on a sensed ΔP to measure an applied force without regard to where in the sensor's range the ΔP occurs.

Use of a configurable absolute barometric sensor with a high dynamic range also provides power savings to the stylus by avoiding or reducing on-board processing. In one implementation, the barometric sensor includes an analog front end with a serial output that may transmit readings to the stylus or to an associated electronic device via direct memory access (DMA). Using DMA, it is possible for the associated electronic device to receive a transmission from the sensor without using, or even waking up, an on-board processor on the stylus to process the sensor output, as may be necessary with a digital sensor output, such as a 12-bit digital output.

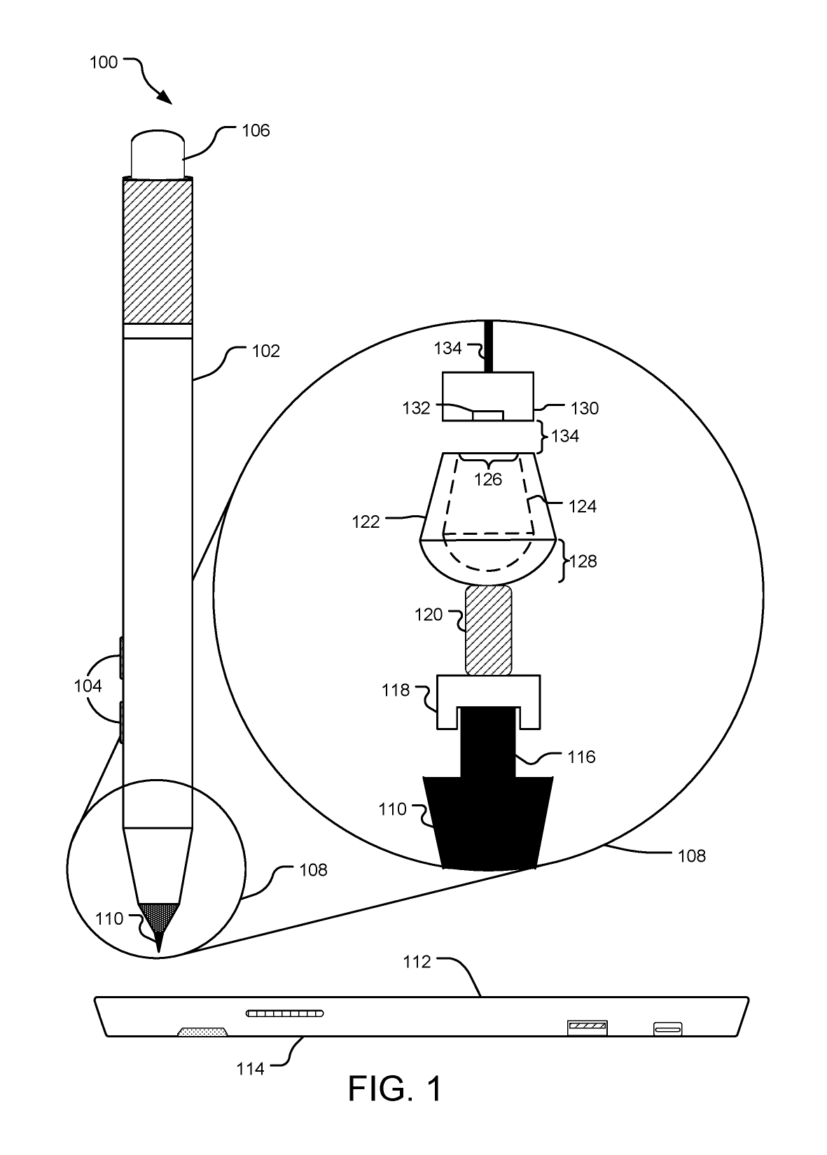

FIG. 1 illustrates an example stylus 100 in a hover mode. The stylus 100 includes a stylus body 102. In an implementation, the stylus body 102 may be formed of a material suitable for enclosing the components described herein. The stylus body 102 may be formed from, for example without limitation, plastic, rubber, metal, carbon fiber, etc., and/or any combinations thereof. In an implementation, the stylus 100 may include one or more physical buttons 104 selectable by a user. Selection of one of the physical buttons 104 may cause a user input to be transmitted to the stylus 100. For example, without limitation, selection of a physical button 104 may select an application program executing on an electronic device with which the stylus communicates according to a wired or wireless communication protocol. Physical buttons 104 may wake the pen from standby mode and/or activate menus and/or other user interface designs on an application executing on an electronic device. In another implementation, physical buttons 104 may select or “click” an element on a graphical user interface on the electronic device via a cursor. In other implementations, the stylus 100 may include a cap button 106. The cap button 106 may be a physical button selectable by the user, and may perform any of the aforementioned functions mentioned with respect to buttons 104. The stylus 100 may include one or more friction areas for facilitating the user's grip and manipulation, such as, for example, a rubber friction area or textured area to increase friction with a user's hand and/or fingers. In an implementation, the stylus 100 includes a tip 110. The tip 110 may be positioned at the distal end of the stylus 100 on the opposite end of the stylus from the physical button 106.

In hover mode, there is no pressure applied to the tip 110 of the stylus 100 (or the pressure is below a minimum ink condition pressure), such as by contact with a screen 112 of an associated electronic device 114. In FIG. 1, components housed inside stylus body 102 are shown in greater detail in bubble 108. Other components in addition to those shown in bubble 108 may be present inside stylus body 102, including without limitation inside stylus body 102 at the distal end near the tip in the area depicted by bubble 108. In an implementation, a tip 110 extends beyond the distal end of the stylus body 102, and is mechanically coupled to a tip holder shaft 116. The tip holder shaft 116 may be vertically disposed inside stylus housing 102. The tip holder shaft 116 and tip 110 may be slidably coupled to the interior of stylus housing 102. When a user applies pressure to tip 110, such as, for example, by pressing the stylus 100 onto the surface of an electronic device, the tip 110 and tip holder shaft 112 may slide in concert inside stylus body 102.

In one implementation, the tip holder shaft 112 may be operatively coupled to a force assembly 118. The force assembly may exert a force on the tip holder 116 and the other components coupled thereto to ensure the tip 110 does not move until a minimum force has been applied. The force assembly 118 may include a spring that may be pre-loaded to a desired amount according to a number of methods. The spring may be pre-loaded using pre-load spacers added to one or both ends of spring, or by using threaded pre-load assemblies, etc. Increasing the amount of pre-loading on the spring in the force assembly 118 will increase the force that must be applied to tip holder 112 via tip 110 to move the spring from a pre-loaded position. In one implementation, the pre-load is greater than the weight of the tip 110, the tip holder shaft 116, and any other components slidably connected to the interior of stylus housing 102, such that the tip 110 will remain in a fully extended position when the user holds the stylus 100 in any orientation, such as a vertical orientation. In this implementation, the tip 110 will remain fully extended when the user applies force to the tip 110, such as when the user wishes to provide input to an electronic device by writing on the surface 112 of the device 114 with the stylus 100, until such time that the user applies more force to the tip 110 than the amount of pre-loading on spring 114. When the user applies more force to the tip 110 than the amount of pre-loading on spring 114, the tip holder shaft 112 will begin to compress spring 114. The spring 114 will continue to compress as force on the tip increases until the spring reaches a maximum compression. In another implementation, the force assembly 118 may include a rubber dome to hold the tip holder 116 and associated components in a fully extended position until the user applies a sufficient force to collapse the rubber dome and compress the force assembly 118. In yet another implementation, the force assembly 118 includes a mechanical switch that may be configured to compress in a variety of ways (e.g., with an operating point, pressure point, reset point, tactile point, etc.) when the user applies a force to tip 110.

In an implementation, the stylus 100 includes a container 122. The container 122 may be formed in a variety of shapes suitable to permit an interior cavity 124 having a volume and an opening in the interior cavity 126 to the ambient fluid pressure. The opening in the interior cavity 126 allows the fluid pressure inside the interior cavity 124 to equalize with the ambient fluid pressure when the stylus 100 is in a hover mode, as in FIG. 1. The container 122 may be formed of a deformable material such that the container 122, and the interior cavity 124, may at least partially collapse to a reduced volume when an outside force is applied. In an implementation, the container 122 may be formed of a material that resists deforming until a minimum force has been applied.

In another implementation, the container 122 includes a cap section 128. In one implementation, the cap section 128 is in the shape of a dome. The cap section 128 may be formed of a different material than the remainder of container 122, such that an applied force will tend to collapse the cap section 128 more readily than the remainder of container 122. The collapse of cap section 128 may be designed to facilitate a reduction in volume in interior cavity 124 when an outside force is applied to the container 122.

The stylus 100 may include a force member 120. In an implementation, the force member 120 may be operatively coupled to the force assembly 118 and to at least a portion of container 122. The force member 120 may be formed according to a variety of shapes suitable to transmit a force applied by a user to container 122 via tip 110, tip holder 116, and force assembly 118, which may be all slidably connected to the inside of stylus body 102. In one implementation, the force member 120 has a flared end in contact with container 122 to distribute an applied force over a greater surface area of the container 122. In another implementation, the force member 120 may include a rounded tip to concentrate the force applied by the user in a relatively smaller region of container 122. The force member 120 may itself be deformable, and may compress between force assembly 118 and container 122 when a user applies a force to tip 110.

In an implementation, a barometric sensor is disposed inside a sensor housing 130 and is in fluid communication with the ambient fluid pressure through an aperture 132 in the sensor housing 130. A surface of the sensor housing may be separated from the container 132 by an air gap 134. The surface of the sensor housing 130 may be smooth to facilitate a seal between the sensor housing and the container 122 when the container slidably cooperates with the sensor housing. In some implementations, the seal is not a complete seal, and some fluid continues to leak out from the interior cavity to the environment when the container slidably cooperates with the sensor housing. The aperture 132 in the sensor housing may be sized to be smaller than the size of the opening 126 in the interior cavity 124. In one implementation, the aperture 132 in the sensor housing may be substantially smaller than the opening 126 in the interior cavity to facilitate a more substantially complete seal around the sensor aperture when the container 122 cooperates with the surface of the sensor housing.

Inside the sensor housing 130, there may be various components including a circuit board, a temperature sensor, one or more strain gauges, electronic components such as a bridge rectifier, etc. The components inside the sensor housing 130 may be communicatively connected to a controller and other components inside the stylus body 102 for transmitting readings from the barometric pressure sensor, the strain gauges, the temperature sensor, etc. The sensor housing may be disposed on the end of a central shaft 134. The central shaft 134 may be fixably attached to the inside of stylus body 102, such that the sensor housing remains stationary when an outside force has been applied by the user via the tip 110 and other components connected thereto.

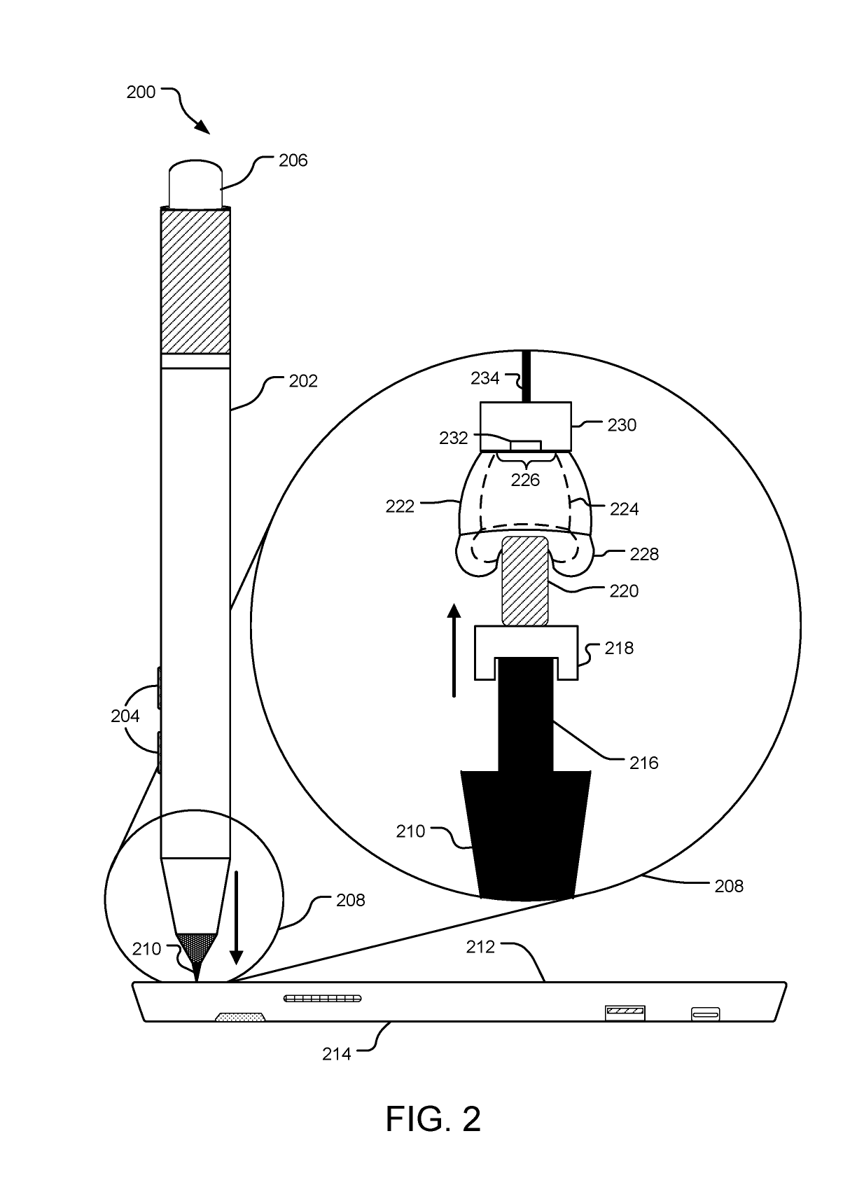

FIG. 2 illustrates an example stylus 200 in an ink mode. The stylus 200 includes a stylus body 202. In an implementation, the stylus body 202 may be formed of a material suitable for enclosing the components described herein. The stylus body 202 may be formed from, for example without limitation, plastic, rubber, metal, carbon fiber, etc., and/or any combinations thereof. In an implementation, the stylus 200 may include one or more physical buttons 204 selectable by a user. Selection of one of the physical buttons 204 may cause a user input to be transmitted to the stylus 200. For example, without limitation, selection of a physical button 204 may select an application program executing on an electronic device with which the stylus communicates according to a wired or wireless communication protocol. Physical buttons 204 may wake the pen from standby mode and/or activate menus and/or other user interface designs on an application executing on an electronic device. In another implementation, physical buttons 204 may select or “click” an element on a graphical user interface on the electronic device via a cursor. In other implementations, the stylus 200 may include a cap button 206. The cap button 206 may be a physical button selectable by the user, and may perform any of the aforementioned functions mentioned with respect to buttons 204. The stylus 200 may include one or more friction areas for facilitating the user's grip and manipulation, such as, for example, a rubber friction area or textured area to increase friction with a user's hand and/or fingers. In an implementation, the stylus 200 includes a tip 210. The tip 210 may be positioned at the distal end of the stylus 200 on the opposite end of the stylus from the physical button 206.

In an ink mode, a user applies pressure to the tip 210 of the stylus 200, such as by contact with a screen 212 of an associated electronic device 214. Components housed inside stylus body 202 are shown in greater detail in bubble 208 as arranged when the stylus 200 is in an ink mode. Other components in addition to those shown in bubble 208 may be present inside stylus body 202, including without limitation inside stylus body 202 at the distal end near the tip in the area depicted by bubble 208. In an implementation, a tip 210 extends beyond the distal end of the stylus body 202, and is mechanically coupled to a tip holder shaft 216. The tip holder shaft 216 may be vertically disposed inside stylus housing 202. The tip holder shaft 216 and tip 210 may be slidably coupled to the interior of stylus housing 202. When a user applies pressure to tip 210, the tip 210 and tip holder shaft 212 may slide in concert inside stylus body 202.

In one implementation, the tip holder shaft 212 may be operatively coupled to a force assembly 218. The force assembly may exert a force on the tip holder 216 and the other components coupled thereto to ensure the tip 210 does not move until a minimum force has been applied. The force assembly 218 may include a spring that may be pre-loaded to a desired amount according to a number of methods. The spring may be pre-loaded using pre-load spacers added to one or both ends of spring, or by using threaded pre-load assemblies, etc. Increasing the amount of pre-loading on the spring in the force assembly 218 will increase the force that must be applied to tip holder 212 via tip 210 to move the spring from a pre-loaded position. In one implementation, the pre-load is greater than the weight of the tip 210, the tip holder shaft 216, and any other components slidably connected to the interior of stylus housing 202, such that the tip 210 will remain in a fully extended position when the user holds the stylus 200 in any orientation, such as a vertical orientation. In this implementation, the tip 210 will remain fully extended when the user applies force to the tip 210, such as when the user wishes to provide input to an electronic device by writing on the surface 212 of the device 214 with the stylus 200, until such time that the user applies more force to the tip 210 than the amount of pre-loading on spring 214. When the user applies more force to the tip 210 than the amount of pre-loading on spring 214, the tip holder shaft 212 will begin to compress spring 214. The spring 214 will continue to compress as force on the tip increases until the spring reaches a maximum compression. In another implementation, the force assembly 218 may include a rubber dome to hold the tip holder 216 and associated components in a fully extended position until the user applies a sufficient force to collapse the rubber dome and compress the force assembly 218. In yet another implementation, the force assembly 218 includes a mechanical switch that may be configured to compress in a variety of ways (e.g., with an operating point, pressure point, reset point, tactile point, etc.) when the user applies a force to tip 210.

In an implementation, the stylus 200 includes a container 222. The container 222 may be formed in a variety of shapes suitable to permit an interior cavity 224 having a volume and an opening in the interior cavity 226 to the ambient fluid pressure. The opening in the interior cavity 226 allows the fluid pressure inside the interior cavity 224 to equalize with the ambient fluid pressure when the stylus 200 is in a hover mode, as in FIG. 1. The container 222 may be formed of a deformable material such that the container 222, and the interior cavity 224, may at least partially collapse when an outside force is applied. In an implementation, the container 222 may be formed of a material that resists deforming until a minimum force has been applied.

In another implementation, the container 222 includes a cap section 228. In one implementation, the cap section 228 is in the shape of a dome. The cap section 228 may be formed of a different material than the remainder of container 222, such that an applied force will tend to collapse the cap section 228 more readily than the remainder of container 222. The collapse of cap section 228 may be designed to facilitate a reduction in volume in interior cavity 224 when an outside force is applied to the container 222.

The stylus 200 may include a force member 220. In an implementation, the force member 220 may be operatively coupled to the force assembly 218 and to at least a portion of container 222. The force member 220 may be formed according to a variety of shapes suitable to transmit a force applied by a user to container 222 via tip 210, tip holder 216, and force assembly 218, which are all slidably connected to the inside of stylus body 202. In one implementation, the force member 220 has a flared end in contact with container 222 to distribute an applied force over a greater surface area of the container 222. In another implementation, the force member 220 may include a rounded tip to concentrate the force applied by the user in a relatively smaller region of container 222. The force member 220 may itself be deformable, and may compress between force assembly 218 and container 222 when a user applies a force to tip 210.

In an implementation, a barometric sensor is disposed inside a sensor housing 230 and is in fluid communication with the ambient fluid pressure through an aperture 232 in the sensor housing 230. A surface of the sensor housing may be separated from the container 232 by an air gap 234. The surface of the sensor housing 230 may be smooth to facilitate a seal between the sensor housing and the container 222 when the container cooperates with the sensor housing. The aperture 232 in the sensor housing may be sized to be smaller than the size of the opening 226 in the interior cavity 224. In one implementation, the aperture 232 in the sensor housing may be substantially smaller than the opening 226 in the interior cavity to facilitate a complete seal around the sensor aperture when the container 222 cooperates with the surface of the sensor housing.

Inside the sensor housing 230, there may be various components including a circuit board, a temperature sensor, one or more strain gauges, etc. The components inside the sensor housing 230 may be communicatively connected to a controller inside the stylus body 202 for transmitting readings from the barometric pressure sensor, the strain gauges, the temperature sensor, etc. The sensor housing may be disposed on the end of a central shaft 234. The central shaft 234 may be fixably attached to the inside of stylus body 202, such that the sensor housing remains stationary when an outside force has been applied by the user via the tip 210 and other components connected thereto.

When a user applies a force to tip 210, force member 220 and container 222 may slidably move towards sensor housing 230, such that the opening 226 of the interior cavity 224 cooperates with the aperture 232 and compresses the container 222 to reduce volume of the interior cavity 224 and increase fluid pressure therein.

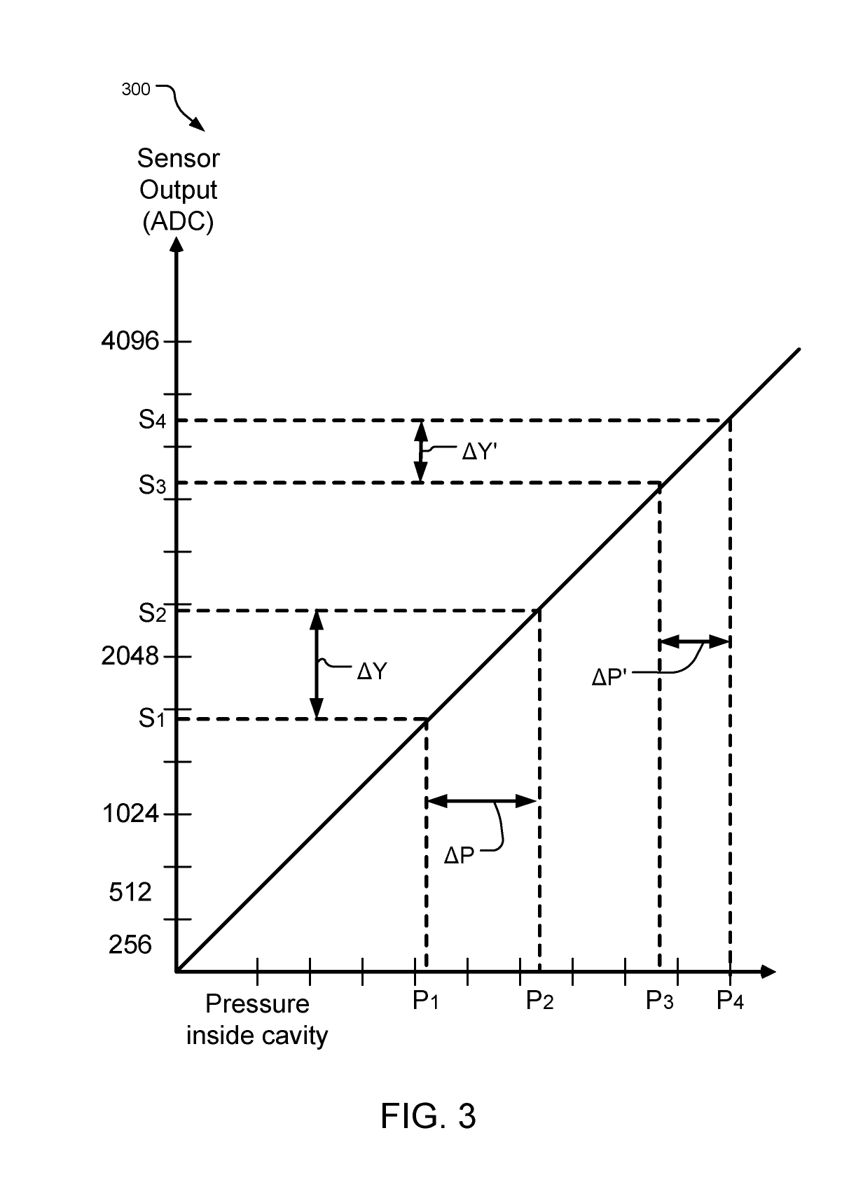

FIG. 3 is a plot of pressure inside the interior cavity of the container as measured by the barometric pressure sensor. The x-axis in the plot represents actual pressure inside the interior cavity and the y-axis in the plot represents the value reported by the sensor. The scale of the y-axis has been converted to a 12-bit scale, such as by an analog-to-digital converter.

In an embodiment, the barometric sensor has a substantially linear response to increasing pressure. As the sensor has a high dynamic range of sensor outputs, the output may be adjusted to cover all expected pressure values expected to be encountered by the device. In one implementation, the barometric pressure sensor output is configured to sense a range of pressures starting at greater than one atmosphere of pressure (i.e., below sea level) up to 0.1 atmospheres of pressure, which is likely lower than the environmental pressure encountered on a pressurized airplane or in a geographic area of high elevation. The output of the sensor may be further configured to account for increased pressure inside the interior cavity of the container. In one implementation, the output of the sensor is further adjusted to account for up to 400 g of force on the tip of the stylus. The increased pressure inside the interior cavity corresponding to 400 g of force on the tip of the stylus is dependent upon the shape and volume chosen for the interior cavity.

The plot in FIG. 3 illustrates the reliance of the force sensing of the device on the ΔP measured by the sensor rather than on any particular pressure value. For example, in one implementation, the stylus tares (or “zeroes”) the sensor when the stylus wakes from a sleep mode into an active mode. If the user is operating the stylus in a geographical area of high elevation, the pressure point at which the sensor tares may be represented by P₁. At point P₁, the sensor may report a reading of S₁. If the user applies a force to the tip of the stylus, the fluid pressure in the interior cavity will increase to P₂ while the container cooperates with the sensor housing. The value reported by the sensor will accordingly climb to S₂. The difference between the sensor outputs S₁ and S₂ may be represented by ΔY, which may be interpreted by the stylus as the ink state value for the force applied by the user. In one implementation, the ink state value may correspond to the thickness of a line the user wishes to draw on an associated electronic device. The ink state value, or ΔY, depends only on the difference between sensor readings S₁ and S₂, and is independent of the actual sensor readings themselves.

In another example, the user of the stylus leaves the geographic area of high elevation, and travels to sea level. When the user awakens the stylus from a sleep mode near sea level, the stylus tares (or “zeroes”) the sensor to a pressure represented by P₃, which corresponds to a sensor reading of S₃. If the user now applies a force to the tip of the stylus, the pressure inside the interior cavity may rise to P₄ because the force will reduce the volume in the interior cavity, and the sensor will report a corresponding value of S₄. As in the prior example, the difference in sensor values may be represented by ΔY′, which may be interpreted by the stylus as the ink state value for the force applied by the user. As before, the ink state value, or ΔY′, depends only on the difference between sensor readings S₃ and S₄, and is independent of the actual sensor readings themselves. In this manner, the force sensor may passively “slide” up and down the linear response curve as environmental pressure conditions change without the need to calibration of the device.

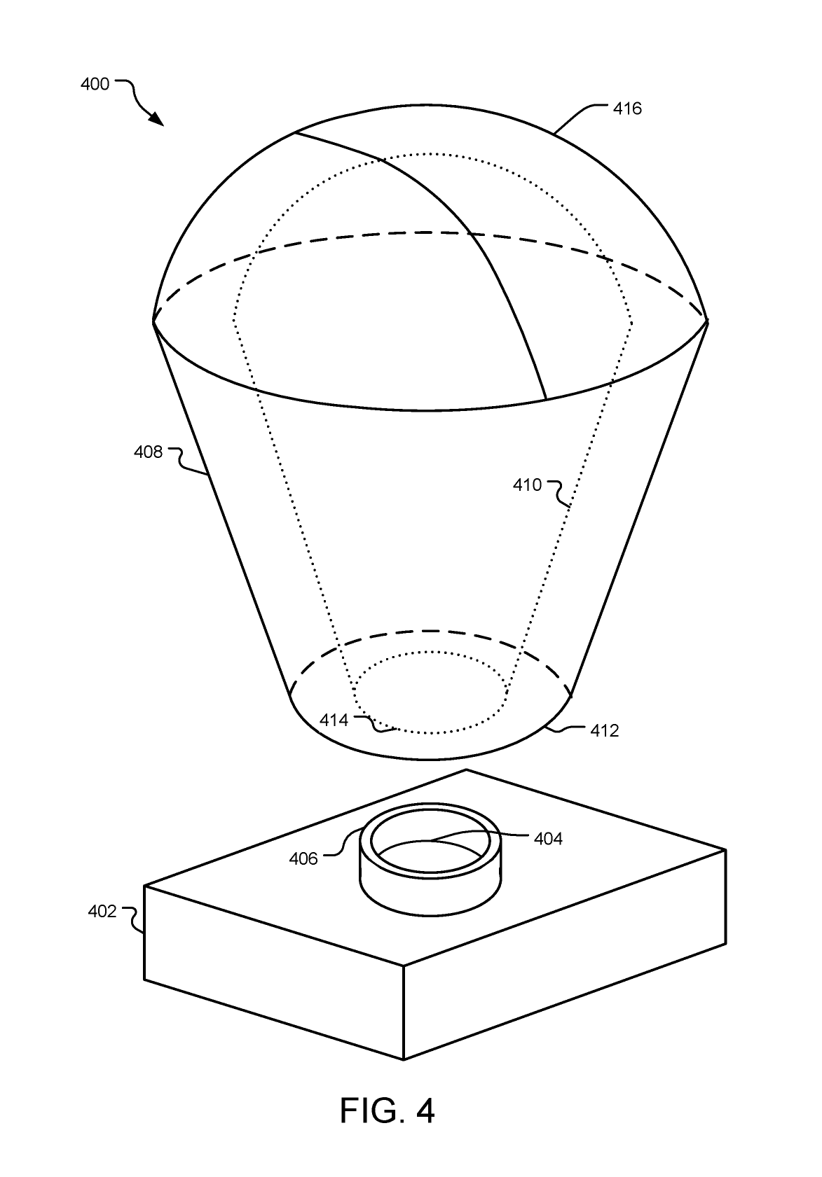

FIG. 4 illustrates an example container 408 with an interior cavity 410 configured to cooperate with the aperture 404 on a barometric sensor housing 402. The container 408 may include a top section 416 that is more easily deformable than the remainder of container 408 to facilitate reduction in volume of the interior cavity 410 when a force is applied to the top section 416. The body of container 408 may be substantially more rigid than top section 416 to maintain a more complete fluid seal between the bottom surface 412 of the container 408 and the top surface of the sensor housing 402 with which the container 408 may cooperate.

The container 408 is slidably coupled to the inside of the stylus body. A force applied to the device slides the container 408 towards the sensor housing 402 until the container contacts the sensor housing 402 and the interior cavity cooperates with the aperture 404 on the barometric sensor housing 402. In an implementation, the top section 416 and/or the body of container 408 are rigid enough not to deform under a force when sliding against the inside of the stylus body, and only begin to deform after the container 408 has stopped moving against the sensor housing 402. Once the container 408 begins to deform, the volume of interior cavity 410 will decrease and fluid pressure inside interior cavity 410 will increase because the fluid able to escape from the interior cavity 410 will be minimized. One way of minimizing escaping fluid is raised annular port 406 in sensor housing 402. The raised annular port 406 may be sized smaller than the opening 414 in interior cavity 410 to permit the raised annular port 406 to fit inside the opening 414. In another embodiment, a skirt section extends from container 408 and interfaces with the sensor housing 402 to guide the container so that the opening 414 does not misalign with the raised aperture 406 and/or assists with creating a seal between the interior cavity 410 and the ambient fluid pressure. Another way to minimize escaping fluid is to provide a smooth surface on the top of the sensor housing 402 to interface with the bottom surface 412 of container 408. Bottom surface 412 of container 408 may include a friction grip, rubber, or other material for decreasing sliding movement against the top of the sensor housing 402. In another implementation, the bottom surface 412 of container 408 and/or the top of sensor housing 402 include a microcellular urethane (e.g., Poron).

When the applied force is removed from the tip of the stylus, the container 408 may slide back up, such that there is an air gap again between the opening 414 and the sensor housing 402. When the container 408 raises back up, the fluid pressure in the interior cavity 410 will equalize with the ambient fluid pressure. The container may be raised up by a force assembly including a pre-loaded spring, a rubber dome, and/or a mechanical switch. In another implementation, the container 408 is raised back up by springs disposed between the sensor housing 402 and the container 408. In yet another implementation, the container 408 is raised back up by wings disposed on the bottom surface 412 of container 408 that collapse when the container 408 presses on the top surface of sensor housing 402 but expand to push against the container when the applied force is removed.

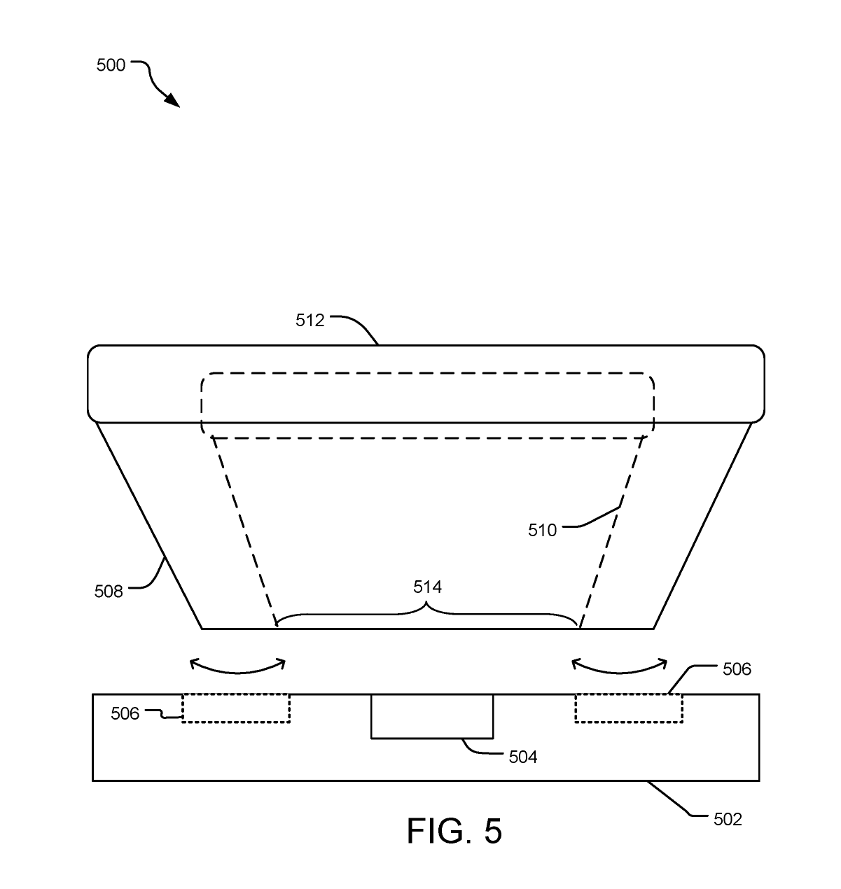

FIG. 5 is another implementation of a container 508 with an interior cavity 510 including an opening 514 from the interior cavity 510 to the ambient fluid pressure. The container 508 is disposed above a sensor housing 502 containing a sensor aperture 504 and two grooves 506 to receive the bottom portion of container 508 when the opening 514 cooperates with the sensor aperture 504. When the container 508 is in a raised position, there is a fluid gap between the opening 514 and the surface of the sensor housing 502. In this position, the fluid pressure inside the interior cavity 510 equalizes with the ambient fluid pressure.

The container 508 may have a top section 512 in a flat shape. The flat shape of top section 512 and a relatively wider body section of container 508 may provide a greater increase of fluid pressure in the interior cavity 510 for a fixed applied force because the flat shape allows for a greater reduction in volume inside the interior cavity 510 than a more rounded cap section would. The shape of cap section 512 and the rest of container 508 may be chosen in this manner to tune the response of the barometric sensor for a given mechanical movement of the force member pressing on the container 508.

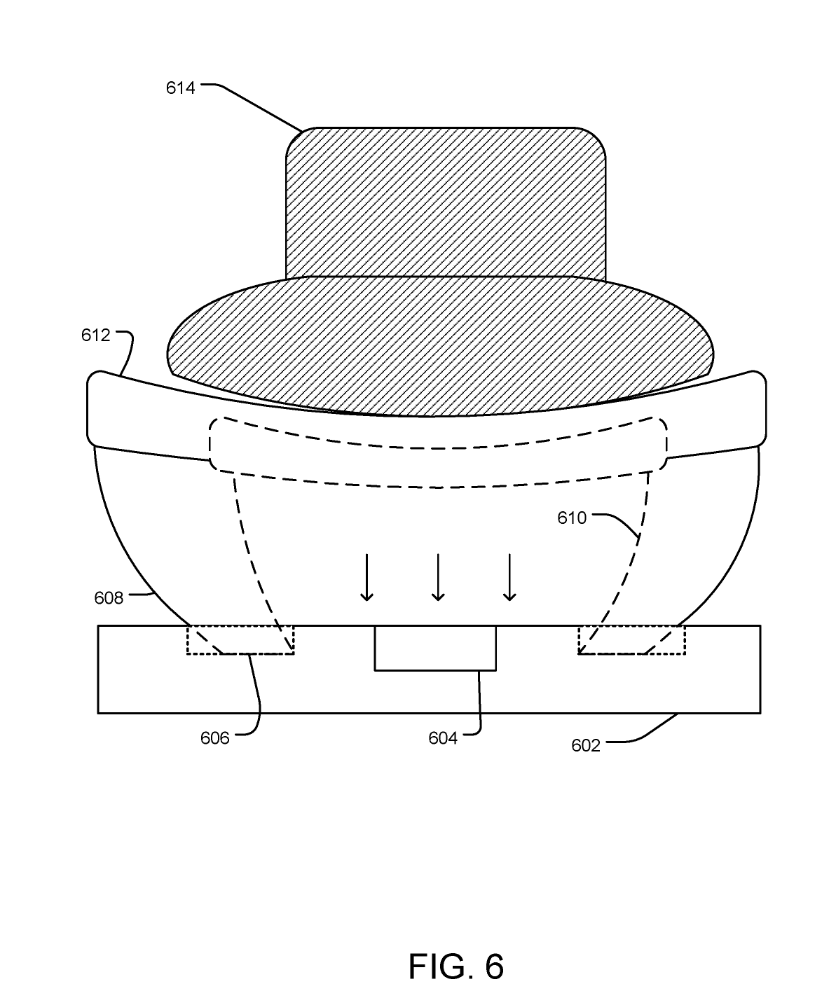

FIG. 6 illustrates another example container 608 with an interior cavity 610 configured to cooperate with the aperture 604 on a barometric sensor housing 602 when a force is applied by force member 614. In an implementation, the sensor housing 602 includes a groove 606 to receive the bottom portion of the container 608. In an implementation, the groove 606 is a circular groove that surrounds the aperture 604 to permit an improved fluid seal between the interior cavity 610 and the surface of the sensor housing 602. Since the seal is dependent on force applied by the force member 614, a harder force will tend to produce a better fluid seal.

When the applied force is removed from the tip of the stylus, the container 608 may slide back up, such that there is an air gap again between the opening 614 and the sensor housing 602. When the container 608 raises back up, the fluid pressure in the interior cavity 610 will equalize with the ambient fluid pressure. The container may be raised up by a force assembly including a pre-loaded spring, a rubber dome, and/or a mechanical switch. In another implementation, the container 608 is raised back up by springs disposed between the sensor housing 602 and the container 608. In yet another implementation, the container 608 is raised back up by wings disposed on the bottom surface 612 of container 608 that collapse when the container 608 presses on the top surface of sensor housing 602 but expand to push against the container when the applied force is removed.

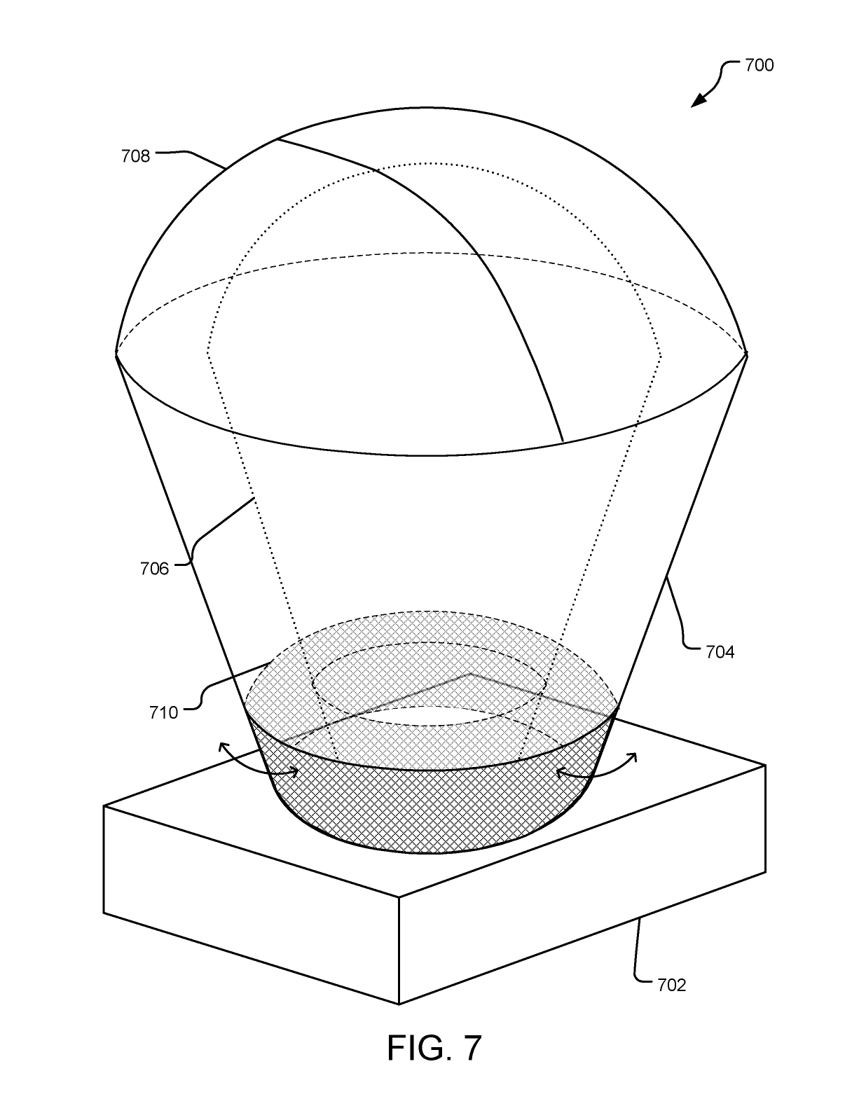

FIG. 7 is another implementation of a container 704 with an interior cavity 706 including a fluidly permeable section 710 between the interior cavity 706 to the ambient fluid pressure. The container 704 is disposed above a sensor housing 702 containing a sensor on the surface of the housing (not shown). The container 704 does not have raised and lowered positions, but rather always sits in contact with the sensor housing 702, regardless of whether a force member applies a force to the top section 708. In an implementation, the fluidly permeable section 710 may be formed of open-cell foam. In the absence of a force applied to the top section 708, the fluid pressure in the interior cavity 706 will tend to equalize with the ambient fluid pressure via the fluidly permeable section 710. The rate at which the interior cavity 706 equalizes with the ambient fluid pressure may be chosen by selecting a material for the fluidly permeable section 710 with greater or lesser fluid permeability. In an implementation, the fluidly permeable section 710 may be located at the bottom of container 704, near the surface of sensor housing 702. In another implementation, the fluidly permeable section may be located elsewhere on container 704, such as near the top section 708 or at any other location on container 704.

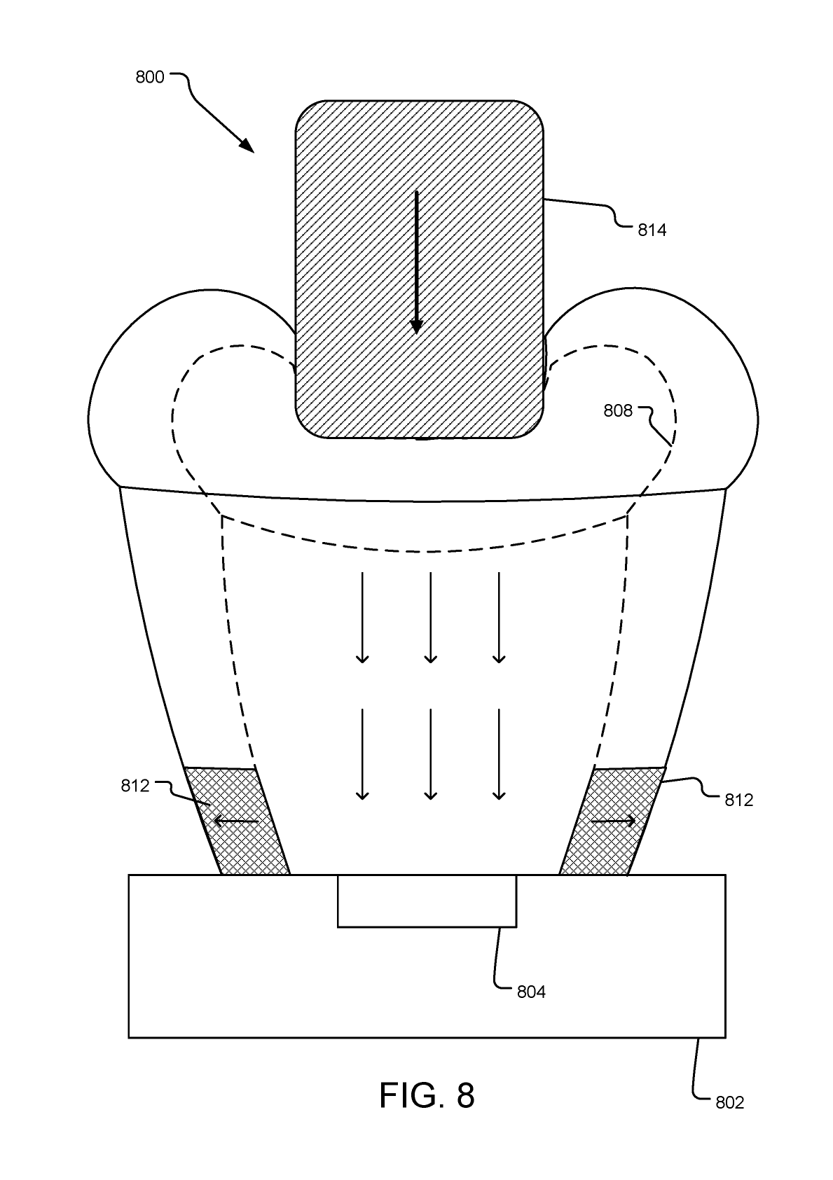

FIG. 8 illustrates another example container 806 with an interior cavity 808 fixed atop a sensor housing 802 including an aperture 804. When the applied force is removed from the tip of the stylus, the container 806 and top section 810 may deform to reduce the volume of interior cavity 808. Although some fluid will escape through fluidly permeable section 812, the resulting increase in fluid pressure inside the interior cavity 808 may still be measured by the barometric sensor via the aperture 804. In one implementation, the leakage caused by fluidly permeable sections 812 may be accounted for when interpreting the measurement of the barometric sensor. For example, a fluidly permeable section 812 may permit the passage of fluid at a rate proportional to the difference in fluid pressure between the interior cavity 808 and the ambient fluid pressure. A controller on the stylus or an electronic device associated with the stylus may calculate this pressure loss, and adjust the estimated force accordingly. In one implementation, a contact force applied to container 806 by force member 814 will result in an initially increasing, then slowly decreasing fluid pressure inside interior cavity 808 as fluid seeps out through fluidly permeable sections 812. The stylus and/or electronic device associated with the stylus may interpret the slowly decreasing fluid pressure inside interior cavity 808 as a constant force.

When the force member 814 retracts and no longer applies a force to cap section 810, then the fluid pressure inside interior cavity 808 may equalize with the ambient fluid pressure. Since the barometric pressure sensor has a high dynamic range, the sensor may tare to the current fluid pressure when the force member 814 retracts, but before the fluid pressure inside interior cavity 808 has fully equalized with the ambient fluid pressure. In one implementation, the barometric pressure sensor tares at discrete time intervals after the force member 814 retracts to prepare to measure the ΔP of another application of force to the top section 810 that may come before the fluid pressure inside interior cavity 808 has fully equalized. Since the container 806 does not need to travel so that the interior cavity 808 cooperates with the aperture 804 in the sensor housing 802 when a force is applied via force member 814, the container 806 may provide a lower activation point for sensing a force than a container that must close an air gap before the fluid pressure in the interior cavity rises.

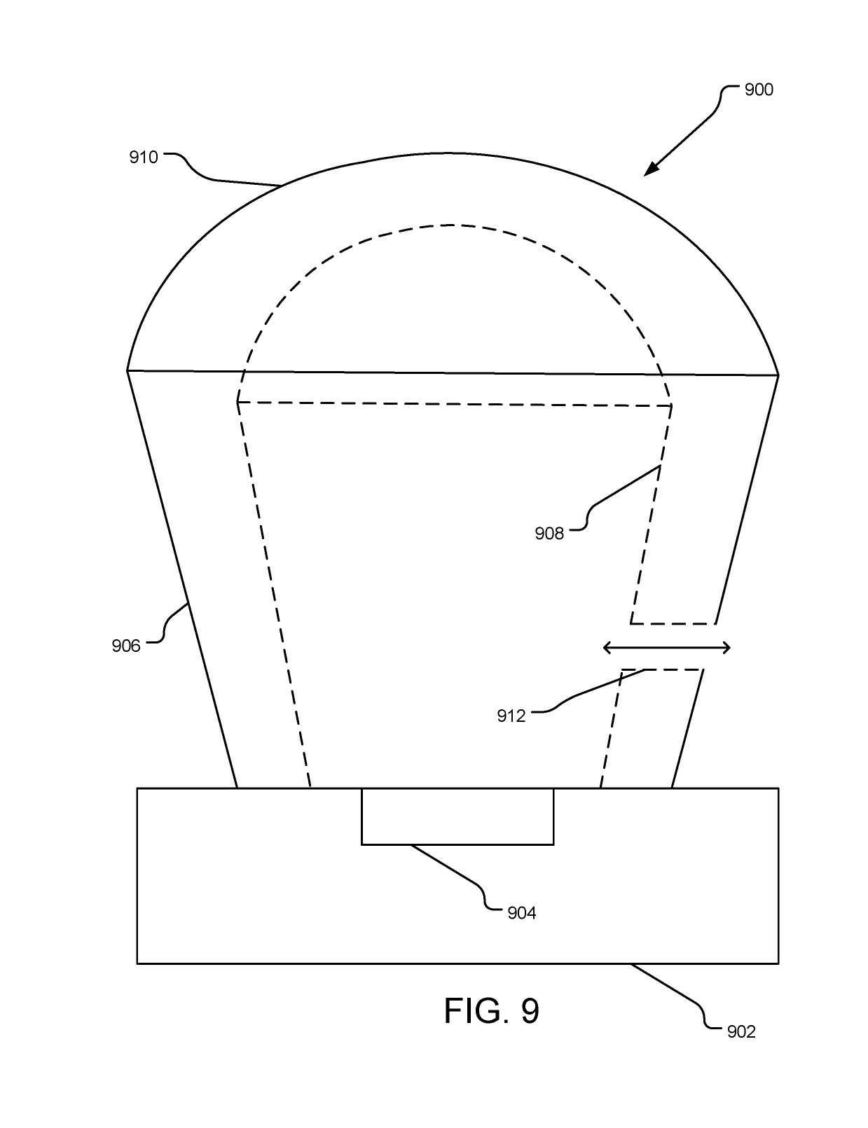

FIG. 9 is another implementation of a container 906 with an interior cavity 908 including a fluid channel 912 between the interior cavity 908 and the ambient fluid pressure. The container 906 is disposed above a sensor housing 902 containing an aperture 904 for a barometric pressure sensor. The container 906 does not have raised and lowered positions, but rather always sits in contact with the sensor housing 902, regardless of whether a force member applies a force to the top section 910. In an implementation, the fluidly channel 912 may be an open channel. In the absence of a force applied to the top section 910, the fluid pressure in the interior cavity 908 will tend to equalize with the ambient fluid pressure via the fluidly channel 912. The rate at which the interior cavity 908 equalizes with the ambient fluid pressure may be chosen by selecting a width for fluid channel 912. In an implementation, the fluidly channel 912 may be located at the bottom of container 906, near the surface of sensor housing 902. In another implementation, the fluidly permeable section may be located elsewhere on container 906, such as near the cap section 910 or at any other location on container 906.

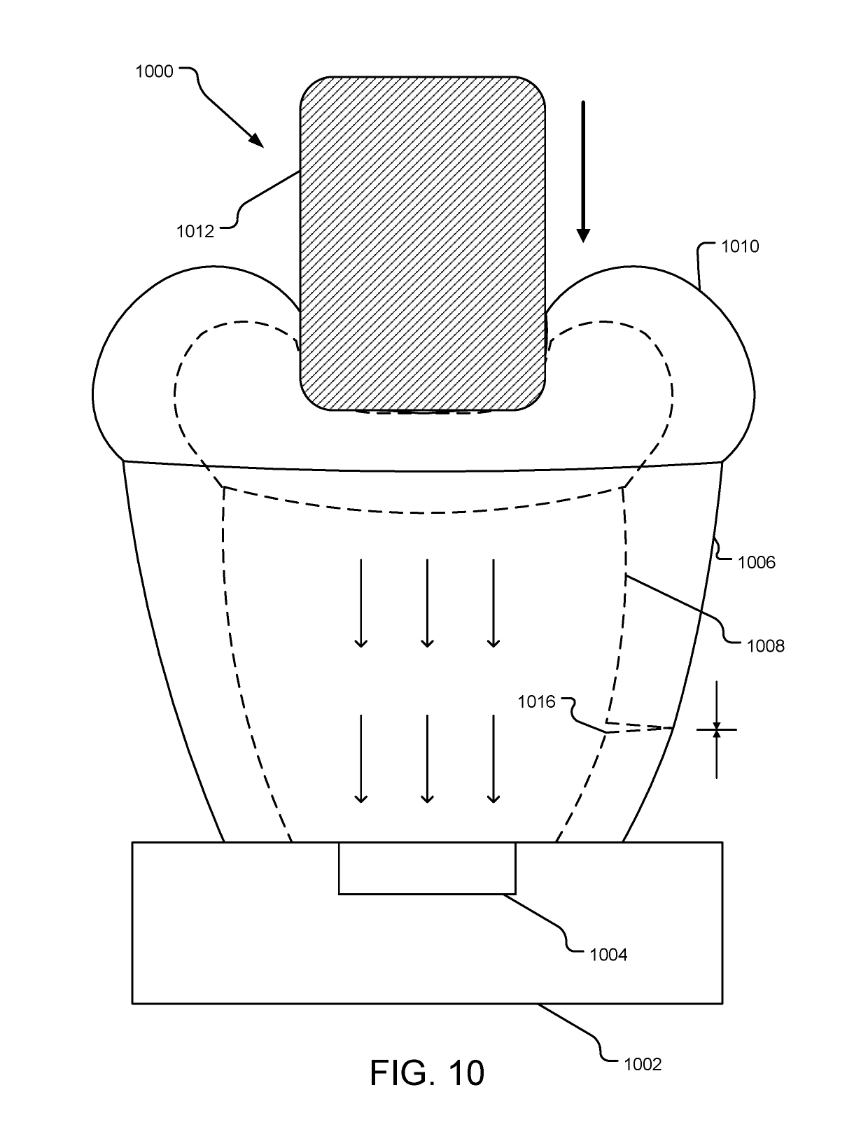

FIG. 10 illustrates another example container 1006 with an interior cavity 1008 fixed atop a sensor housing 1002 including an aperture 1004. When a force is applied to the tip of the stylus, force member 1012 may transmit the applied force to the container 1006 and cap section 1010, which may deform to reduce the volume of interior cavity 1008. Although some fluid will escape through fluid channel 1016, the fluid channel 1016 may be configured to collapse under the force of force member 1012 to partially or completely seal the fluid channel 1016, such that fluid leakage is reduced or eliminated. Even with some fluid leakage, the resulting increase in fluid pressure inside the interior cavity 1008 may still be measured by the barometric sensor via the aperture 1004. In one implementation, the leakage caused by fluid channel 1016 may be accounted for when interpreting the measurement of the barometric sensor.

When the force member 1012 retracts and no longer applies a force to cap section 1010, then the fluid pressure inside interior cavity 1008 may equalize with the ambient fluid pressure via fluid channel 1016. Since the barometric pressure sensor has a high dynamic range, the sensor may calibrate to a zero level at the current ambient fluid pressure when the force member 1012 retracts, but before the fluid pressure inside interior cavity 1008 has fully equalized with the ambient fluid pressure. In one implementation, the barometric pressure sensor tares at discrete time intervals after the force member 1012 retracts to prepare to measure the ΔP of another application of force to the top section 1010 that may come before the fluid pressure inside interior cavity 1008 has fully equalized. Since the container 1006 does not need to travel so that the interior cavity 1008 cooperates with the aperture 1004 in the sensor housing 1002 when a force is applied via force member 1012, the container 1006 may provide a lower activation point for sensing a force than a container that must close an air gap before the fluid pressure in the interior cavity rises.

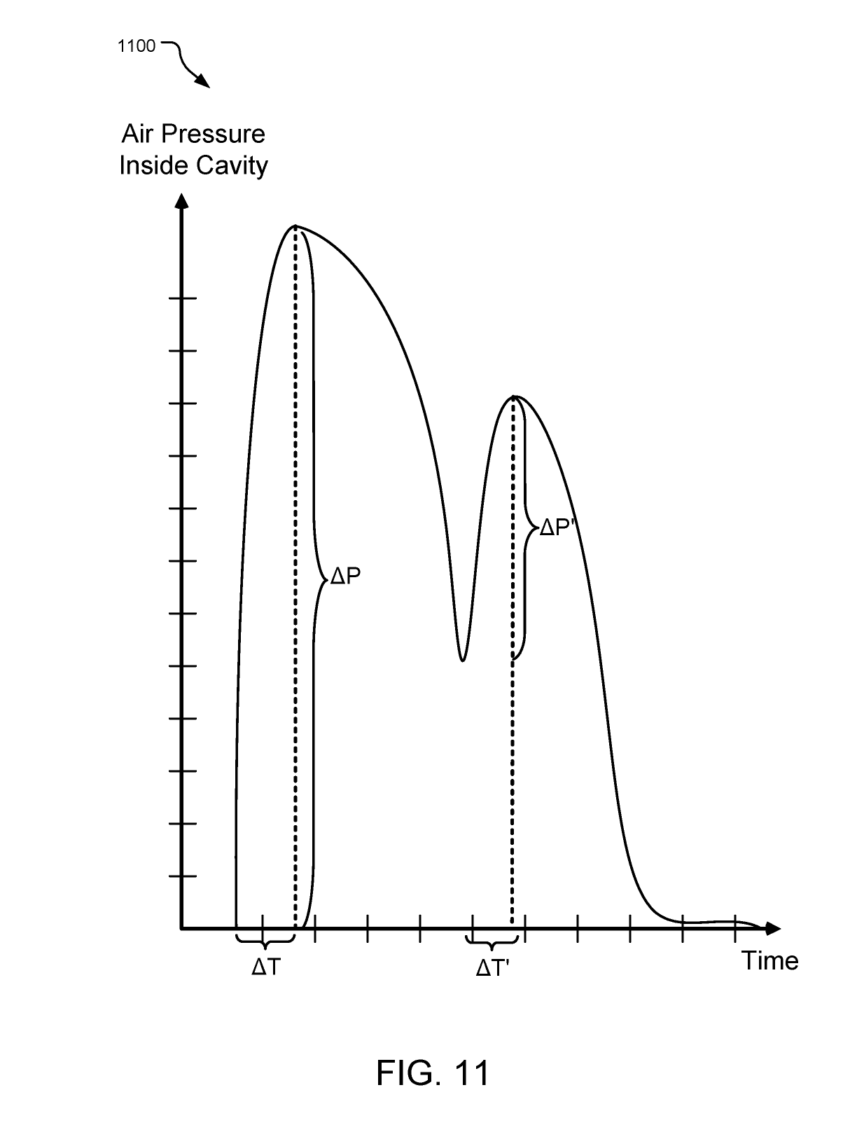

FIG. 11 is a plot of fluid pressure inside the interior cavity of a container against time when a force has been applied by a force member. The x-axis of the plot represents time, and the y-axis of the plot represents pressure inside the interior cavity of a container relative to a tare level. In one implementation, the zero point on the y-axis represents the fluid pressure measured by a barometric sensor at power-up, before the user has applied a force to the tip of the stylus, e.g., the zero point represents the ambient fluid pressure. At the beginning of a first time interval, ΔT, the user begins to apply a force to the tip of the stylus, and a force member compresses the container, thus reducing the volume inside the interior cavity and accordingly increasing the fluid pressure inside the interior cavity until the fluid pressure reaches a local maximum for a total fluid pressure change designated by ΔP. The stylus may interpret ΔP as corresponding to a measured applied force. In one implementation, ΔP corresponds to an ink thickness transmitted to an electronic device associated with the stylus.

At the end of the time period represented by ΔT, the fluid pressure inside the interior cavity begins to return to the ambient fluid pressure level, i.e., the zero level on the plot. Before the fluid pressure in the interior cavity reaches the ambient fluid pressure, the user applies another force to the tip of the stylus at the beginning of time period ΔT′. This second application of force causes the fluid pressure inside the interior cavity to begin to rise again until the end of time period ΔT′ for a gain of ΔP′. In an implementation, the stylus does not measure applied force based on the actual value of P, but rather based on the values of ΔP and ΔP′. Near the end of the plot of FIG. 11, the fluid pressure inside the interior cavity returns to the level of the ambient fluid pressure.

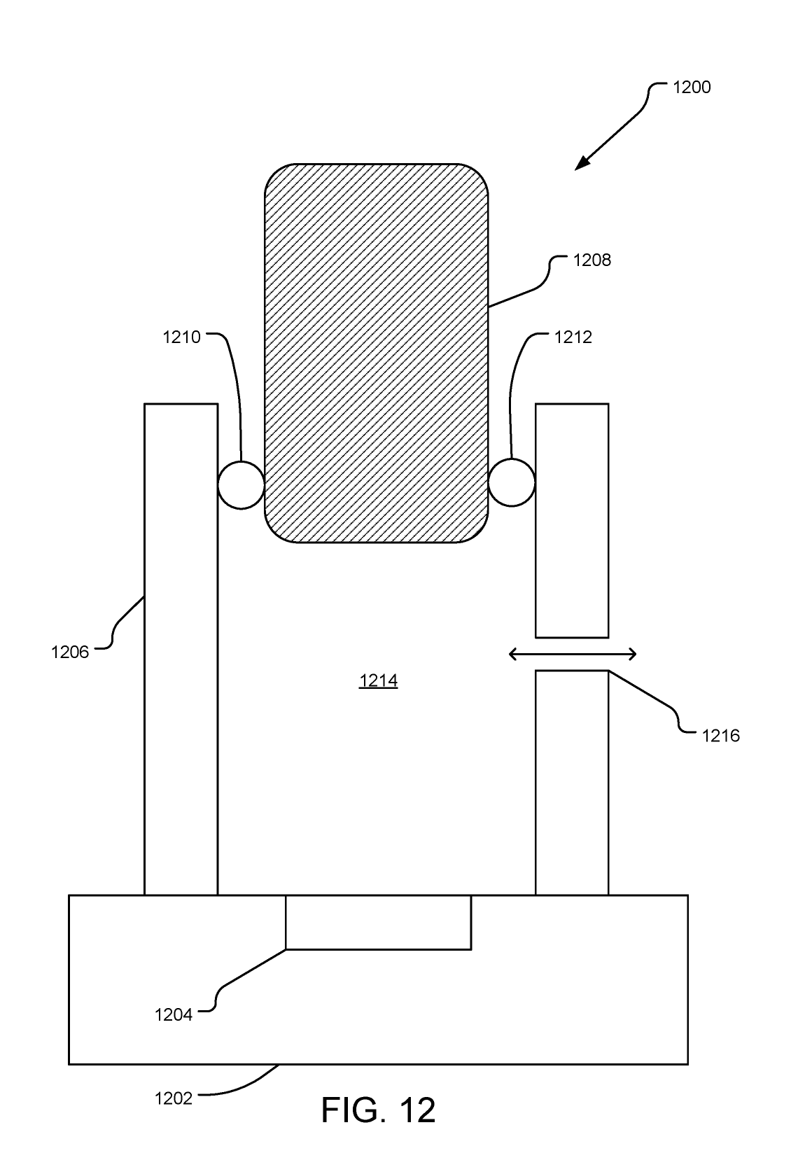

FIG. 12 is another implementation of a container 1206 with an interior cavity 1214 including a fluid channel 1216 between the interior cavity 1214 and the ambient fluid pressure. The container 1206 is disposed above a sensor housing 1202 containing an aperture 1204 for a barometric pressure sensor. The container 1206 does not have raised and lowered positions, but rather always sits in contact with the sensor housing 1202. A force member 1208 forms a portion of the walls of container 1206. In an implementation, the force member 1208 forms the top wall of the container 1206, and is slidably insertable into the interior cavity 1214 according to rollers 1210 when a force is applied to the tip of the stylus. In the absence of a force applied to the force member 1208, the fluid pressure in the interior cavity 1214 will tend to equalize with the ambient fluid pressure via the fluid channel 1216. The rate at which the interior cavity 1214 equalizes with the ambient fluid pressure may be chosen by selecting a width for fluid channel 1216. In an implementation, the fluid channel 1216 may be located at the bottom of container 1206, near the surface of sensor housing 1202. In another implementation, the fluid channel 1216 may be located elsewhere on container 1206, such as near the force member 1208 or at any other location on container 1206.

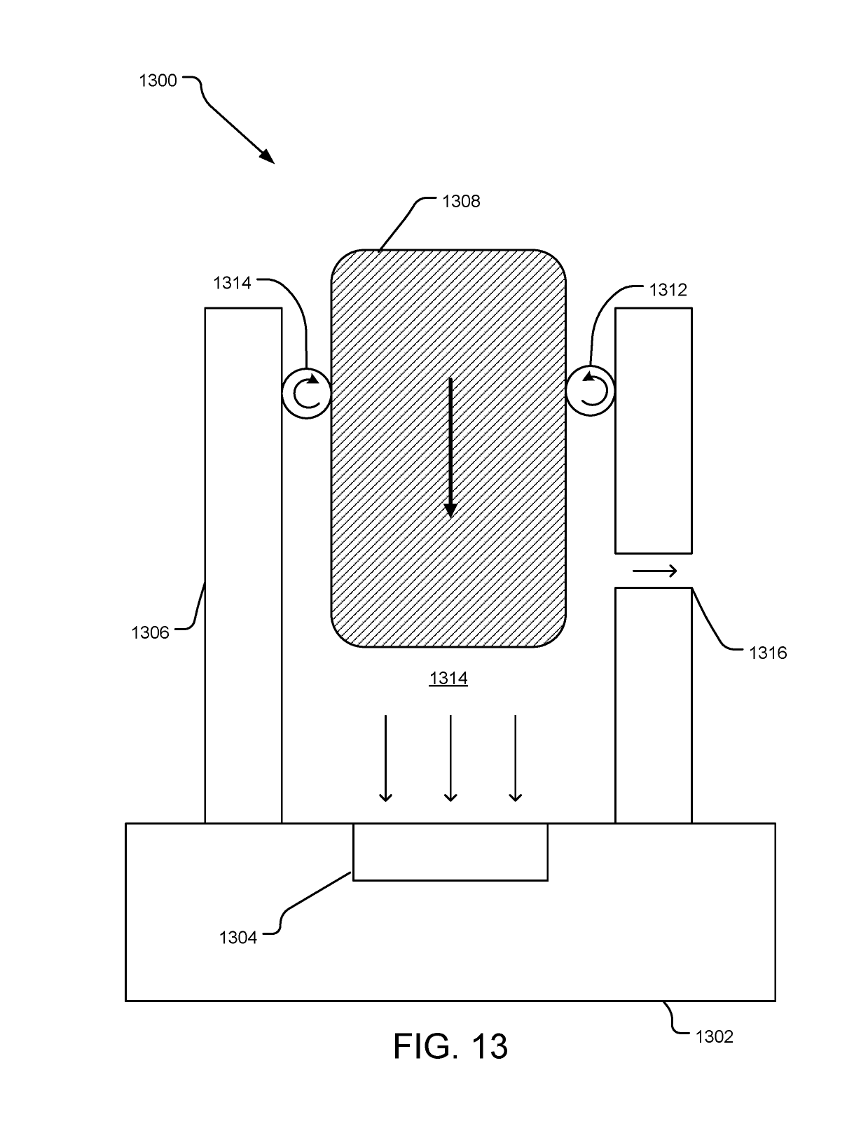

FIG. 13 illustrates another example container 1306 with an interior cavity 1314 fixed atop a sensor housing 1302 including an aperture 1304. When a force is applied to the tip of the stylus, force member 1308 may slidably insert into, and reduce the volume of, interior cavity 1314. Although some fluid will escape through fluid channel 1316, the resulting increase in fluid pressure inside the interior cavity 1314 may still be measured by the barometric sensor via the aperture 1304. In one implementation, the leakage caused by fluid channel 1316 may be accounted for when interpreting the measurement of the barometric sensor.

When the force member 1308 retracts from the interior cavity 1314, then the fluid pressure inside interior cavity 1314 may equalize with the ambient fluid pressure via fluid channel 1316. Since the barometric pressure sensor has a high dynamic range, the sensor may calibrate to a zero level at the current fluid pressure when the force member 1308 retracts, but before the fluid pressure inside interior cavity 1314 has fully equalized with the ambient fluid pressure. In one implementation, the barometric pressure sensor tares at discrete time intervals after the force member 1308 retracts to prepare to measure the ΔP of another application of force to force member 1308 that may come before the fluid pressure inside interior cavity 1314 has fully equalized. Since the container 1306 does not need to travel so that the interior cavity 1314 cooperates with the aperture 1304 in the sensor housing 1302 when a force is applied via force member 1308, the configuration of container 1306 may provide a lower activation point for sensing a force than a container that must close an air gap before the fluid pressure in the interior cavity rises.

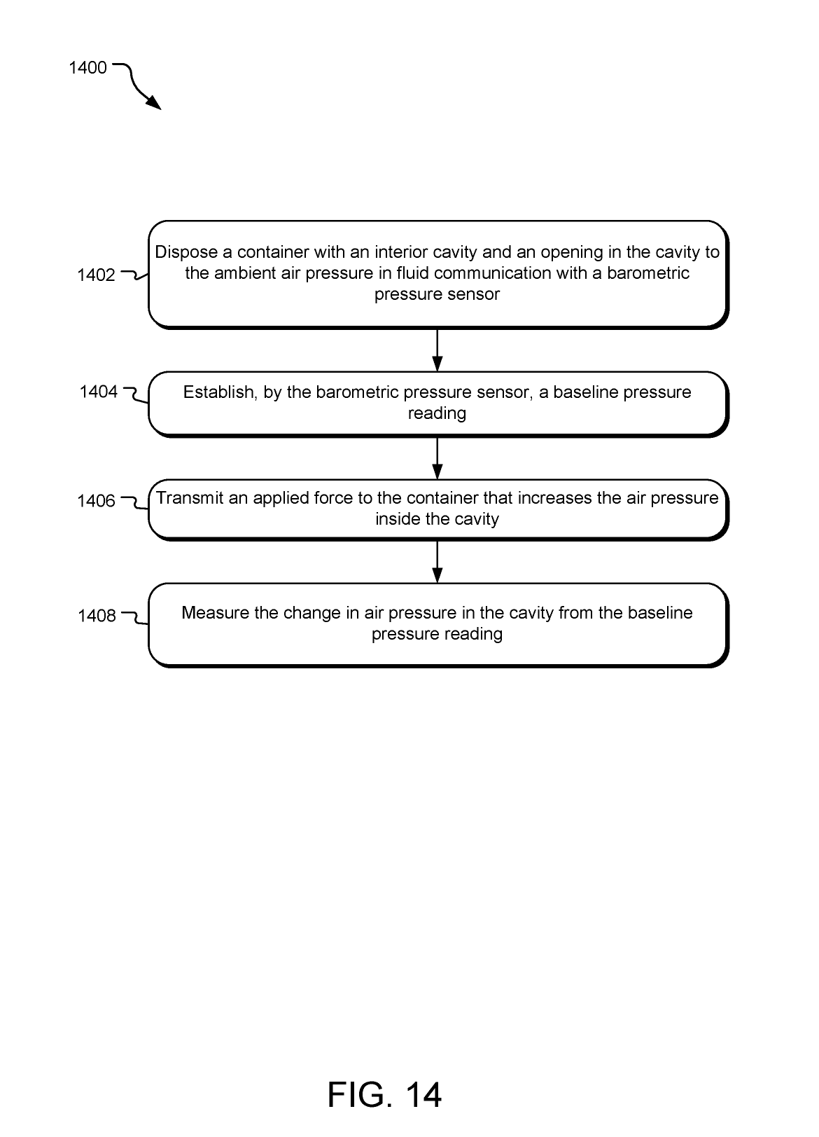

FIG. 14 illustrates example operations 1400 for sensing an applied force using a barometric sensor. Step 1402 is disposing a container with an interior cavity and an opening the interior cavity to the ambient fluid pressure in fluid communication with a barometric pressure sensor. The container may be slidably connected to the inside of a peripheral device, and in mechanical connection with a portion of the device, such as the tip of a stylus. When a user applies a force to the tip of the stylus, a force member in contact with a portion of the container may slide the container towards a sensor housing, such that the opening in the interior cavity cooperates with the aperture in the sensor housing. In an implementation, there is a force assembly between the tip of the stylus and the force member configured to compress until a minimum force has been applied before the force member will transmit the force to the container. The force assembly may include a pre-loaded spring, a rubber dome, and/or a mechanical switch.

Step 1404 of operations 1400 is establishing, by the barometric pressure sensor, a baseline pressure reading. In one implementation, the baseline pressure reading is of the ambient fluid pressure, such as, for example, when the stylus wakes up from a sleep mode, and before the user has applied a force to the tip. In another implementation, the baseline pressure reading is taken after a force has been applied to the tip, but before the fluid pressure in the interior cavity has returned to ambient fluid pressure. Taking the baseline pressure reading before the fluid pressure in the interior cavity has returned to an ambient fluid pressure may be advisable for the sensor to be able to measure an additional application of force to the tip of the stylus that may occur in the time period before the interior cavity returns to ambient fluid pressure.

The next step, step 1406, is transmitting an applied force to the container that increases the fluid pressure inside the interior cavity. In one implementation, the applied force at least partially deforms the container to reduce the volume of the interior cavity located therein. In another implementation, a force member comprises at least partially a wall of the interior cavity, and the applied force slides the force member into the container, thus reducing the volume of the interior cavity and increasing fluid pressure therein. The last step is 1408, measuring the change in fluid pressure in the interior cavity from the baseline pressure reading. The change in fluid pressure in the interior cavity from the baseline pressure reading may be referred to as ΔP, and may represent a measurement of the force applied to the tip of the stylus.

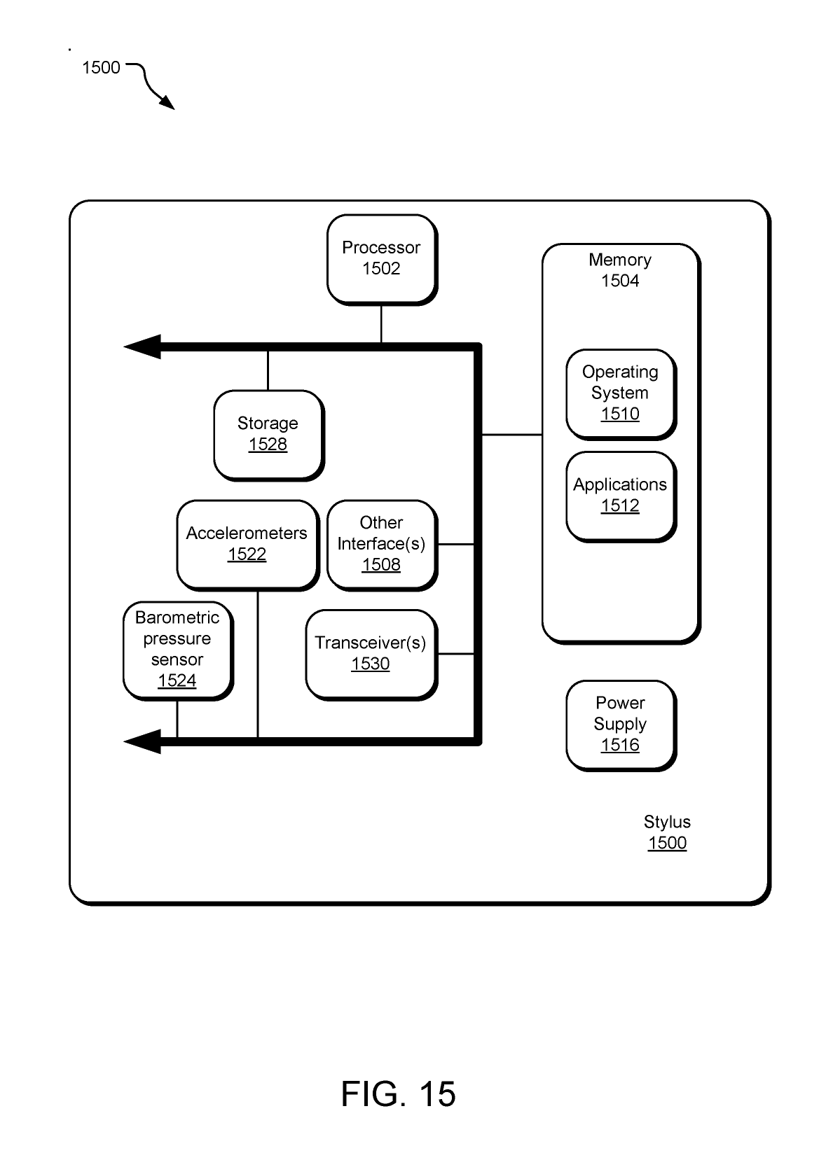

FIG. 15 illustrates an example system (labeled as a stylus 1500) that may be useful in implementing the described stylus. The stylus 1500 includes a processor 1502, a memory 1504, and other interfaces 1508 (e.g., a buttons, fingerprint scanner, etc.). The memory 1504 generally includes both volatile memory (e.g., RAM) and non-volatile memory (e.g., flash memory). An operating system 1510, such as the Microsoft Windows® Phone operating system, resides in the memory 1504 and is executed by the processor 1502, although it should be understood that other operating systems may be employed.

One or more application programs 1512 are loaded in the memory 1504 and executed on the operating system 1508 by the processor 1502. The one or more application programs may include data and routines for executing the methods and stylus apparatus disclosed herein. For example, the applications 1512 may include routines and methods for controlling the barometric pressure sensor, communicating with an associated electronic device, processing data received from the barometric pressure sensor and any other sensors or devices disclosed herein. The stylus 1500 includes a power supply 1516, which is powered by one or more batteries or other power sources and which provides power to other components of the stylus 1500. The power supply 1516 may also be connected to an external power source that overrides or recharges the built-in batteries or other power sources.

The stylus 1500 includes one or more communication transceivers 1530 to provide network connectivity (e.g., mobile phone network, Wi-Fi®, BlueTooth®, etc.). The stylus 1500 also includes various other components, such as one or more accelerometers 1522, a barometric pressure sensor 1524, and additional storage 1528. Other configurations may also be employed.

In an example implementation, a mobile operating system, various applications, and other modules and services may be embodied by instructions stored in memory 1504 and/or storage devices 1528 and processed by the processing unit 1502. The instructions stored in memory 704 may include instructions for activating a power system in the stylus 1500, instructions for measuring electrical characteristics of circuits in the stylus 1500, instructions for measuring characteristics of environmental conditions surrounding the stylus 1500, instructions for measuring pressure via a barometric pressure sensor 1524, and/or for storing data relating to measurements. User preferences, service options, and other data may be stored in memory 1504 and/or storage devices 1528 as persistent datastores.

Stylus 1500 may include a variety of tangible computer-readable storage media and intangible computer-readable communication signals. Tangible computer-readable storage can be embodied by any available media that can be accessed by the stylus 1500 and includes both volatile and nonvolatile storage media, removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by stylus 1500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The stylus may communicate with an electronic device according to a variety of methods. In one implementation, the stylus may contain a Bluetooth™ antenna and communicate with an electronic device according to the Bluetooth™ wireless protocol. In another implementation, the stylus may contain a Wi-Fi antenna and communicate, directly or indirectly, with an electronic device according to one or more Wi-Fi wireless protocols. In other implementations, the stylus may communicate with an electronic device according to a wired connection, for example without limitation a Universal Serial Bus (USB) connection. The stylus may utilize one of the aforementioned communications protocols, or similar communications protocols, to communicate a variety of data to an electronic device. In one implementation, the stylus may pair with an electronic device according to one of the communications protocols. Further, and as explained in more detail below, the stylus may communicate data to an electronic device including position data, mode of operation data, input data, etc.

The stylus may advantageously allow a memory for on board storage of user files received via a wired or wireless connection to the electronic device. The stylus may contain a processor configured to execute code stored on the memory such as operating system code or code downloaded to the stylus over a digital communications channel. The stylus may further advantageously contain a glass display to determine or display to the user any of the following: the power status of the battery, the current wireless signal strength, or other information relating to an electronic device configured to receive user input from the stylus.

An example apparatus includes a pressure member configured to transmit an applied force. A barometric pressure sensor having a sensor housing and an aperture is disposed in the sensor housing. A container having an interior cavity and an opening in the interior cavity is in fluid communication with ambient fluid pressure. The interior cavity is subject to a decrease in volume and an increase in fluid pressure by a force applied by the pressure member. The container is configured to cooperate with and form at least a partial fluid seal around the aperture in the sensor housing to communicate at least part of the increase in fluid pressure to the barometric pressure sensor.

Another example apparatus of any preceding apparatus includes an interior cavity that is in fluid communication with the ambient fluid pressure at least partially via open cell foam.

Another example apparatus of any preceding apparatus includes a fluid communication between the interior cavity with the ambient fluid pressure is at least partially restricted when the force applied by the pressure member satisfies a choke condition.

Another example apparatus of any preceding apparatus includes a pressure member forms a part of a wall of the interior cavity and reduces volume inside the interior cavity by moving into the interior cavity.

Another example apparatus of any preceding apparatus includes a container and the opening in the interior cavity slidably cooperate with the aperture in the sensor housing before the pressure member increases fluid pressure inside the interior cavity.

Another example apparatus of any preceding apparatus includes an aperture in the sensor housing includes a raised annular port, the raised annular port fitting at least partially inside the opening in the interior cavity when the container and the opening in the interior cavity slidably cooperate with the aperture in the sensor housing.

Another example apparatus of any preceding apparatus includes a force assembly configured to establish a minimum force to slideably move the container.

Another example apparatus of any preceding apparatus includes a force assembly includes at least one of: a pre-loaded spring, a rubber dome, and a mechanical switch.

Another example apparatus of any preceding apparatus includes an aperture in the sensor housing that includes a groove, the groove configured to cooperate with at least a portion of the bottom of the container when the container and the opening in the interior cavity slidably cooperate with the aperture in the sensor housing.

Another example apparatus of any preceding apparatus includes a container including a deformable cap section.

Another example apparatus of any preceding apparatus includes a deformable cap section in the shape of a dome.

Another example apparatus of any preceding apparatus includes a deformable cap section that is substantially flat.

Another example apparatus of any preceding apparatus includes a barometric pressure sensor that is an absolute pressure sensor.

An example method includes sensing an applied force including disposing a container with an interior cavity and an opening in the interior cavity to ambient fluid pressure in fluid communication with a barometric pressure sensor, establishing, by the barometric pressure sensor, a baseline pressure reading, transmitting an applied force to the container that increases the fluid pressure inside the interior cavity, and measuring, by the barometric pressure sensor, the change in fluid pressure in the interior cavity from the baseline pressure reading.

Another example method of any preceding method includes communicating the measured change in fluid pressure to an associated electronic device if the measured change in fluid pressure satisfies a minimum pressure condition.

Another example method of any preceding method includes identifying, by a computer processor, a device state depending on the measured change in fluid pressure.

Another example method of any preceding method includes the baseline pressure reading is a reading of the ambient fluid pressure.

An example stylus peripheral includes a stylus body, a tip slidably disposed at the distal end of the stylus body, a container having an interior cavity and an opening in the interior cavity to ambient fluid pressure, and a force assembly connected to the tip and slidably disposed inside the stylus body, the force assembly configured to transmit a force applied to the tip to the container to reduce the volume of the interior cavity.

Another example stylus peripheral of any preceding stylus peripheral includes a barometric pressure sensor in fluid communication with the interior cavity, and configured to sense a change in fluid pressure inside the interior cavity, and a communications assembly configured to communicate the sensed change in fluid pressure by the barometric pressure sensor in the interior cavity from the ambient fluid pressure to an associated electronic device.

Another example stylus peripheral of any preceding stylus peripheral includes a container cooperates with a housing of a barometric pressure sensor in fluid communication with the interior cavity to form at least a partial fluid seal.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. An apparatus comprising:
a pressure member configured to transmit an applied force;
a barometric pressure sensor having a sensor housing and an aperture in the sensor housing;
a container having an interior cavity and an opening in the interior cavity in fluid communication with ambient fluid pressure, the interior cavity subject to a decrease in volume and an increase in fluid pressure by a force applied by the pressure member, the container configured to cooperate with and form at least a partial fluid seal around the aperture in the sensor housing to communicate at least part of the increase in fluid pressure to the barometric pressure sensor.

2. The apparatus of claim 1, wherein the interior cavity is in fluid communication with the ambient fluid pressure at least partially via open cell foam.

3. The apparatus of claim 1, wherein the fluid communication between the interior cavity with the ambient fluid pressure is at least partially restricted when the force applied by the pressure member satisfies a choke condition.

4. The apparatus of claim 1, wherein the pressure member forms a part of a wall of the interior cavity and reduces volume inside the interior cavity by moving into the interior cavity.

5. The apparatus of claim 1, wherein the container and the opening in the interior cavity slidably cooperate with the aperture in the sensor housing before the pressure member increases fluid pressure inside the interior cavity.

6. The apparatus of claim 5, wherein the aperture in the sensor housing includes a raised annular port, the raised annular port fitting at least partially inside the opening in the interior cavity when the container and the opening in the interior cavity slidably cooperate with the aperture in the sensor housing.

7. The apparatus of claim 5, further comprising:
a force assembly, the force assembly configured to establish a minimum force to slideably move the container.

8. The apparatus of claim 7, wherein the force assembly includes at least one of: a pre-loaded spring, a rubber dome, and a mechanical switch.

9. The apparatus of claim 5, wherein the aperture in the sensor housing includes a groove, the groove configured to cooperate with at least a portion of the bottom of the container when the container and the opening in the interior cavity slidably cooperate with the aperture in the sensor housing.

10. The apparatus of claim 1, wherein the container includes a deformable cap section.

11. The apparatus of claim 10, wherein the deformable cap section is in the shape of a dome.

12. The apparatus of claim 10, wherein the deformable cap section is substantially flat.

13. The apparatus of claim 1, wherein the barometric pressure sensor is an absolute pressure sensor.

14. A method of sensing an applied force comprising:
disposing a container with an interior cavity and an opening in the interior cavity to ambient fluid pressure in fluid communication with a barometric pressure sensor;
establishing, by the barometric pressure sensor, a baseline pressure reading;
transmitting an applied force to the container that increases the fluid pressure inside the interior cavity; and
measuring, by the barometric pressure sensor, the change in fluid pressure in the interior cavity from the baseline pressure reading.

15. The method of claim 14, further comprising communicating the measured change in fluid pressure to an associated electronic device if the measured change in fluid pressure satisfies a minimum pressure condition.

16. The method of claim 14, further comprising identifying, by a computer processor, a device state depending on the measured change in fluid pressure.

17. The method of claim 14, wherein the baseline pressure reading is a reading of the ambient fluid pressure.

18. A stylus peripheral comprising:
a stylus body;
a tip slidably disposed at the distal end of the stylus body;
a container having an interior cavity and an opening in the interior cavity to ambient fluid pressure; and
a force assembly connected to the tip and slidably disposed inside the stylus body, the force assembly configured to transmit a force applied to the tip to the container to reduce the volume of the interior cavity.

19. The stylus peripheral of claim 18, further comprising:
a barometric pressure sensor in fluid communication with the interior cavity, and configured to sense a change in fluid pressure inside the interior cavity;
a communications assembly configured to communicate the sensed change in fluid pressure by the barometric pressure sensor in the interior cavity from the ambient fluid pressure to an associated electronic device.

20. The stylus peripheral of claim 18, wherein the container cooperates with a housing of a barometric pressure sensor in fluid communication with the interior cavity to form at least a partial fluid seal.
